(19) United States
(12) Patent Application Publication
(10) Pub. No.: US 2013/0132146 A1
(43) Pub. Date: May 23, 2013

(54) MODEL PLANT CONSTRUCTION SYSTEMS AND PROCESSES

(71) Applicants: Michael Pye, Anderson, SC (US); Ivo Willems, Houston, TX (US)

(72) Inventors: Michael Pye, Anderson, SC (US); Ivo Willems, Houston, TX (US)

(73) Assignee: FLUOR TECHNOLOGIES CORPORATION, Aliso Viejo, CA (US)

(21) Appl. No.: 13/301,585

(22) Filed: Nov. 21, 2011

(51) Int. Cl. G06Q 10/06

(52) U.S. Cl. 705/7.22; 705/7.27

(57) ABSTRACT

In methods for managing congestion points of a plant lifecycle, access can be provided to a project database, as well as a congestion engine coupled with the project database. The congestion engine can be used to analyze project designs, resources, and activities. At least one congestion object can be generated based at least in part upon the analysis of the congestion engine. A project interface can be configured to present the at least one congestion object.

### FIELD OF THE INVENTION

The field of the invention is systems and methods for modeling a plant lifecycle.

### BACKGROUND

During a plant's lifecycle, it is quite common to encounter points of congestion in during the construction phase (e.g., a welder is scheduled to complete his work two feet above a worker who is schedule to connect a junction box), as well as during the operations, maintenance and other phases of a plant lifecycle. Despite the common occurrence of congestion points in later phases of a plant lifecycle, earlier phases of the plant's lifecycle such as design and engineering phases typically fail to account for potential congestion points despite the benefit of reducing or eliminating delays, additional costs, and other problems associated with the potential congestion.

Various systems and methods for managing a project's construction are described in U.S. Pat. No. 5,016,170 to Pollalis et al., U.S. Pat. No. 5,369,570 to Parad, U.S. Pat. No. 6,842,760 to Dorgan et al., and U.S. patent publ. no. 2005/0010459 to Kawabata et al. (publ. January 2005). While such systems and methods manage aspects of a plant's construction such as resources needed and scheduling of tasks, they fail to account for potential congestion points in pre-construction phases that could occur during and after the plant's construction.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for systems and methods configured to manage congestion points of a plant lifecycle.

### SUMMARY OF THE INVENTION

The inventive subject matter provides apparatus, systems and methods in which one can identify and manage potential congestion points early on in a plant lifecycle, such that delays and other issues that could result from the identified congestion points during the construction and later phases of the plant lifecycle can be mitigated. As used herein, the term “plant lifecycle” includes the design/proposal, engineering, detailed design, construction, operation, maintenance, or end of life phases of a plant.

For example, contemplated systems and methods can be configured to automatically conduct an analysis of potential congestion problems when a construction schedule is completed and before the construction phase has begun, and more preferably before commencing a detailed engineering phase. By identifying potential issues before the detailed engineering phase, the potential congestion points can be mitigated early on in the plant lifecycle, which advantageously can reduce the time and cost that could otherwise be required to manage congestion points in the detailed engineering or later phases. Such analysis can also take into account congestion points that could occur during operation, maintenance, and end of life phases of the plant lifecycle, even before plant construction has begun. This is quite advantageous over known maintenance-related design, which typically involves a maintenance engineer manually conducting a maintainability review.

In one aspect, methods for managing congestion points include providing access to a project database and a congestion engine coupled with the project database. Project designs, resources, and activities can be analyzed by the congestion engine, and at least one congestion object can be generated based at least in part upon the analysis of the congestion engine. A project interface can preferably be configured to present the at least one congestion object.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a diagram of one method for managing congestion points of a plant lifecycle.

FIG. 2 is a schematic of one embodiment of a system configured to manage congestion points of a plant lifecycle.

FIG. 3 is a schematic of one embodiment of a management interface.

FIG. 4 is a schematic of one embodiment of a project interface.

### DETAILED DESCRIPTION

It should be noted that while the following description is drawn to a computer/server based congestion point modeling system for a plant lifecycle, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

One should appreciate that the disclosed techniques provide many advantageous technical effects including the ability to automatically, or semi-automatically, identify and manage congestion points that could occur in a plant lifecycle, such that the congestion points are preferably mitigated early on in the plant lifecycle. In this manner, the impact of the congestion points on subsequent phases of the plant lifecycle can be minimized and potentially eliminated, which can advantageously (i) reduce or eliminate problems due to production bottlenecks, (ii) facilitate the timely procurement of necessary materials, or (iii) otherwise insure the timely completion, proper operation, and required maintenance of a plant.

Contemplated congestion points can include any congestion that could or will arise during the plant lifecycle, and therefore might impact one or more phases of a plant lifecycle. In contrast to actual conflicts, congestion points represent a potential for congestion or other problems that may occur in the plant lifecycle and may be based upon previously-identified congestion points at the same or different plants, a location of and resources needed for a particular task, and/or schedules associated with a construction or other phases of the plant lifecycle. Exemplary congestion points could include, for example, scheduling congestion, space congestion, resource congestion, inclement weather, and other types of congestion.

Scheduling congestion could include, for example, (1) a person, team, or piece of equipment is scheduled to be in different places at overlapping times, (2) a second task is scheduled that requires completion of a first task that may not be completed by the scheduled time, (3) recently laid concrete prevents usage of a road by trucks or other vehicles needed at another area of the plant construction, (4) conduit is scheduled to be laid, but excavation is not yet completed, or (5) one congestion point could delay another project of the plant construction.

Examples of space congestion can include (1) two tasks scheduled at the same location that has a space constraint where only one task can be worked on at a time, (2) a cement truck may be blocking a road needed by a dump truck, (3) building materials are being stored in a location that requires excavation, or (4) a section of a building provides insufficient space for conducting maintenance of an electrical panel.

Resource congestion can include, for example, (1) a specific piece of equipment is needed to complete overlapping tasks, (2) a task is scheduled but necessary supplies will not be available, (3) a shortage of materials occurs; (4) a piece of necessary equipment breaks or malfunctions; (5) workers become ill or go on strike; or (6) building materials delivered but a crane is not available to move the materials.

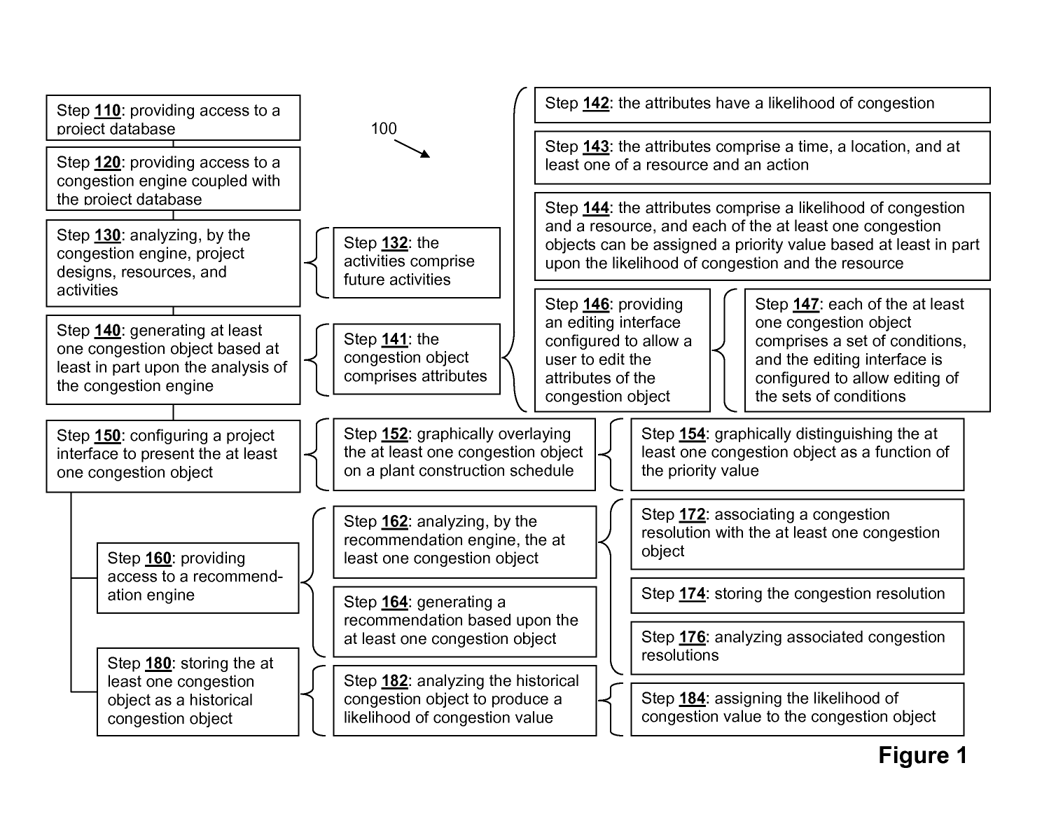

In FIG. 1, an embodiment of a method 100 for managing congestion points of a plant lifecycle is illustrated, which includes step 110 of providing access to a project database that advantageously can store information related to one or more plant constructions. Exemplary project databases include those utilized in plant design software such as SmartPlant™ sold by Intergraph™, and any other commercially suitable databases.

In step 120, access can be provided to a congestion engine coupled with the project database, such that the congestion engine can access the information stored in the project database. Such information can include, for example, location information, plant construction start and end dates, and resources required to complete the plant construction. The project database could further include information related to the operation and maintenance of other plants.

In step 130, the congestion engine can be configured to analyze information related to current and past project designs such as constructions schedules, historical congestion points, resources needed during the plant lifecycle, or projects or other activities, all of which is preferably stored in the project database but could alternatively be stored in one or more databases coupled with the congestion engine. For example, it is contemplated that the project designs could be stored in a design re-use library such as that described in co-pending WIPO application titled “Plant Deliverable Management System” having serial no. PCT/US10/60535 filed on Dec. 15, 2010.

The project designs could include previous iterative designs of the current plant and/or designs of past or planned plant constructions distinct from the current plant. Resources could include, for example, equipment, materials, money, and manpower. Activities could include various tasks required to complete a plant construction, and can also include future activities in step 132, such as tasks related to the operation, maintenance, and end of life phases of the plant lifecycle.

In some contemplated embodiments, the congestion engine can be configured to interact with modularization technology including, for example, that described in co-pending U.S. pat. appl. titled “Modular Processing Facility” having Ser. no. 12/971,365 and filed on Dec. 17, 2010, and WIPO pat. publ. no. 2011/075625 to Fluor Technologies Co. (publ. June 2011). In this manner, the congestion engine can be configured to analyze modularization-based projects.

Based at least in part upon the analysis of the congestion engine, one or more congestion objects can be generated in step 140 that each represents one or more potential congestion points. In especially preferred embodiments, the congestion engine can be used early on during the design and/or engineering phases of a plant lifecycle either in real-time or when desired by a user to identify potential congestion points that could occur in future phases of the plant lifecycle. By identifying the potential congestion points, this advantageously allows the user the opportunity to mitigate potential congestion points early on in the plant lifecycle and in some cases, even before a detailed design phase has commenced.

In one aspect, the congestion engine could utilize one or more algorithms to conduct a comparison of the planned activities in each phase of a plant lifecycle with similar activities of past projects to generate the congestion objects. The comparison could include analyze the circumstances surrounding congestion points encountered in past projects and compare those circumstances with likely circumstances of the planned activities to determine whether such congestion points could occur as a result of the planned activities, and if so, what is the likelihood that the congestion will occur.

The congestion engine's analysis could additionally or alternatively include a comparison of the resources necessary for the planned activities with the availability of those resources to generate congestion objects. For example, should one or more of the planned activities require a scarce resource, it is more probable that a congestion point could arise with respect to those activities should that resource become unavailable. As another example, should one or more of the planned activities require the same resource, the congestion engine could analyze the likelihood that one activity's use of that resource might impact another activity's use of the same resource. The analysis could also take into account a historical availability of resources needed to determine whether each resource is likely to be available when needed.

In another aspect, the congestion engine might also analyze one or maps representing at least a portion of the area where the plant will be constructed as well as potentially representing surrounding area to identify thoroughfares where various pieces of equipment will pass, and areas where materials and equipment will be placed when not in use. For example, if every piece of equipment and delivery truck must utilize a narrow road to reach the construction site, there is likely a greater potential for congestion than for sites having multiple access routes.

It is further contemplated that the congestion engine might also analyze schedules associated with the plant lifecycle and compare scheduled activities for each day, week, month or other time period with the historical weather data for that period to determine the potential for congestion based upon historical weather trends. For example, if a schedule has a planned activity to pour concrete when rain or other inclement weather has historically occurred, there is a potential for congestion since the concrete pouring could be delayed by weather. In contrast, indoor activities are less likely to be impacted by the weather.

Because of the potential for the generation of a near limitless number of congestion objects, the congestion engine could be configured to filter out those congestion points that are more or less theoretical (i.e., very unlikely). This could be accomplished by limiting the congestion engine's analysis to congestion points with a likelihood of congestion over a defined threshold, such that highly unlikely congestion can be disregarded. However, the filter might also take into account the priority of each identified congestion point, such that if the priority is greater than a defined threshold, the congestion point may be included even if the likelihood of congestion is less than the defined threshold discussed above. For example, if a congestion point is identified that has a likelihood of occurring in 1:1000 plant lifecycles but should it occur the plant construction would be delayed by more than one month, the congestion point would likely have a higher priority because of its potential devastating impact on the plant construction and may therefore be included.

Even with such filters, it is contemplated that a plant lifecycle could include hundreds, if not thousands, tens of thousands, or even hundreds of thousands, of congestion objects, depending upon the scale of the plant. Each of the congestion objects can represent a potential congestion that could arise during the plant lifecycle, and can be based upon information related to the plant lifecycle including, for example, construction and maintenance schedules, operation guides, plant layouts, required resources for projects, and locations of the various projects. Each of the congestion objects preferably include one or more attributes (step 141), such as an identifier, a likelihood of congestion (“LOC”) (step 142), a priority, a time or time period of the potential congestion, a location of the potential congestion, a resource related to the potential congestion, other associated congestion objects, potential resolution(s) to mitigate the potential congestion, an actual congestion value, and/or an action (e.g., chosen resolution) (step 143).

The “time” attribute can be used to indicate the context related to the congestion point. This is important because a congestion point could have a different importance or required response depending upon the context (e.g., a construction phase versus a maintenance phase). For example, a congestion point representing a scheduling congestion during a construction phase might have more important than a congestion point representing the scheduling congestion during a maintenance phase if the maintenance phase had additional leeway concerning when tasks are completed.

It is contemplated that the LOC value for a congestion object could be based upon the attributes of that congestion object. For example, a LOC value of a congestion object representing a scheduling congestion of a resource might be based upon conflicting time and/or location values where that resource is required. A LOC of a congestion object representing space congestion, for example, might be based upon a location and a specific resource.

Time values could include, for example, a start time for a project or task, an estimated duration, a completion time, and so forth. Location values could include, for example, an initial location, a current location, and so forth. Resource values could include, for example, a material, a piece of equipment, a worker, a cost, and so forth. Action values could include, for example, move materials from one location to another, pour concrete, and so forth.

In step 144, the congestion objects each preferably includes a LOC attribute and a resource attribute, and each can be assigned a priority value based at least in part upon the LOC and resource values. For example, if multiple congestion objects are associated with a resource having limited availability, those congestion objects might have a higher priority value because of the higher demand for that limited resource and therefore the higher likelihood that resource could become unavailable.

Based upon their respective priority values, it is contemplated that the congestion objects can be ranked or otherwise prioritized such that congestion objects having higher priority values can be presented to a user before those congestion objects having lower priority values. This prioritization could occur on a graphical interface, which can display the congestion objects for the user, and preferably allows in step 154 for congestion objects with greater priority values to be differentiated in some manner from congestion objects with lower priority values. For example, a congestion object could be graphically distinguished by utilizing different sizes, shapes, shadings, colors, emphases, and so forth, which advantageously allows a user to identify a specific group of congestion objects based upon one or more filters. This is especially helpful for construction projects having thousands of congestion objects, or more, as the differentiated congestion objects can allow a user to readily distinguish between low and high priority congestion objects.

Alternatively or additionally, the priority values can be used to generate pop-ups, emails, or other alerts relating to congestion objects requiring immediate attention of a user.

In other contemplated embodiments, a risk of congestion could be calculated by analyzing priority and likelihood of congestion values of the congestion points to determine the potential impact and likelihood of that impact occurring in a plant construction.

In step 146, a management interface can be provided that is configured to allow a user to edit one or more attributes of a congestion object. In this manner, a congestion object can be edited to change a resource attribute, a time attribute, and/or other attributes, such that the potential congestion can be mitigated. In step 147, the congestion objects can also include a set of conditions, which define when the congestion objects will each be generated by the congestion engine, and could also define what is required to resolve the potential congestion. Using the editing interface, one or more of the conditions could be modified as needed to ensure the congestion object is properly generated and resolved.

In step 150, a project interface can be configured to present the at least one congestion object, and preferably includes a graphical user interface that permits filtering or sorting of congestion objects based upon one or more criterion. In some contemplated embodiments, one or more of the congestion objects can be graphically overlaid in step 152 on a plant construction schedule via the project interface or other suitable interface. For example, the graphic overlay could include two-dimensional and/or three-dimensional representations, and could be presented chronologically, by how the congestion varies as a function of time overall or with respect to one or more locations, resources, or other criteria, by location, by specific view, or by other suitable organizational structures.

In step 160, access can optionally be provided to a recommendation engine configured to analyze in step 162 the at least one congestion object generated by the congestion engine. The analysis could take into account attributes associated with the congestion object such as time, location and resource values, associated congestion objects, past projects, and other relevant information. From this analysis, a recommendation that includes one or more suggested congestion resolutions can be generated to mitigate the potential congestion represented by the congestion object. The recommendation could further include an analysis of each identified congestion resolution, such that any potential benefits or downfalls associated with the congestion resolution can be presented with the recommendation.

An exemplary recommendation could suggest amending a construction schedule to change a time value associated with a particular project. It is contemplated that each recommendation can be associated with multiple congestion objects where implementation of a congestion resolution suggested by the recommendation could resolve the associated congestion objects.

It is contemplated that a user can select a congestion resolution suggested by the recommendation generated by the recommendation engine's analysis in step 162, or alternatively could edit the congestion object to thereby manually enter a congestion resolution. In step 172, a congestion resolution selected by the user can be associated with the at least one congestion object, and can be stored in step 174 in a resolution database or other suitable location.

The stored congestion resolutions can be analyzed in step 176 by the recommendation engine, such that future recommendations could be based at least in part on the stored congestion resolutions. In some contemplated embodiments, the congestion resolutions can be incorporated into a rules algorithm used by the recommendation engine, and stored in one or more databases, such that future decisions consider previous congestion resolutions. This advantageously allows the recommendation engine to have a self-learning capacity where recommendations can be generated based upon prior congestion resolutions, and the recommendations could thus change over time depending upon the selected congestion resolutions associated with the congestion objects.

In step 180, the at least one congestion object can optionally be stored as a historical congestion object. Typically, the at least one congestion object will be stored after a resolution has been identified; although it is contemplated that congestion objects without an associated resolution could also be stored. A LOC value can be assigned to the stored congestion object in step 184, which can be analyzed in step 182 to produce a LOC value for future generated congestion objects.

The historical congestion object could include any recommendations or congestion resolutions associated with the at least one congestion object such as for later analysis. During a plant lifecycle, each of the historical congestion objects could be updated by the congestion engine or other suitable engine to further include whether the potential congestion actually occurred, which can be used to modify the conditions upon which the congestion object is generated and/or increase the accuracy of future recommendations to resolve that congestion object. In some contemplated embodiments, the congestion engine could analyze camera feeds, changes to construction and other schedules, unexpected movement of materials, and other external information to determine whether congestion has occurred in the plant lifecycle. For example, a last-minute change in the schedule might indicate actual congestion associated with one or more activities.

The LOC values will typically represent a likelihood of delay in the construction project, although the likelihood of the congestion will typically be independent of the length of the potential delay.

In preferred embodiments, the congestion engine can re-conduct its analysis of the plant lifecycle after congestion resolutions have been associated with one or more of the congestion objects to determine whether the associated congestion resolutions generate additional congestion objects. Even more preferably, such analysis could occur simultaneously or in conjunction with the analysis of the recommendation engine, such that recommendations generated in step 164 could include what additional congestion points, if any, would be generated for each congestion resolution suggested by the recommendation.

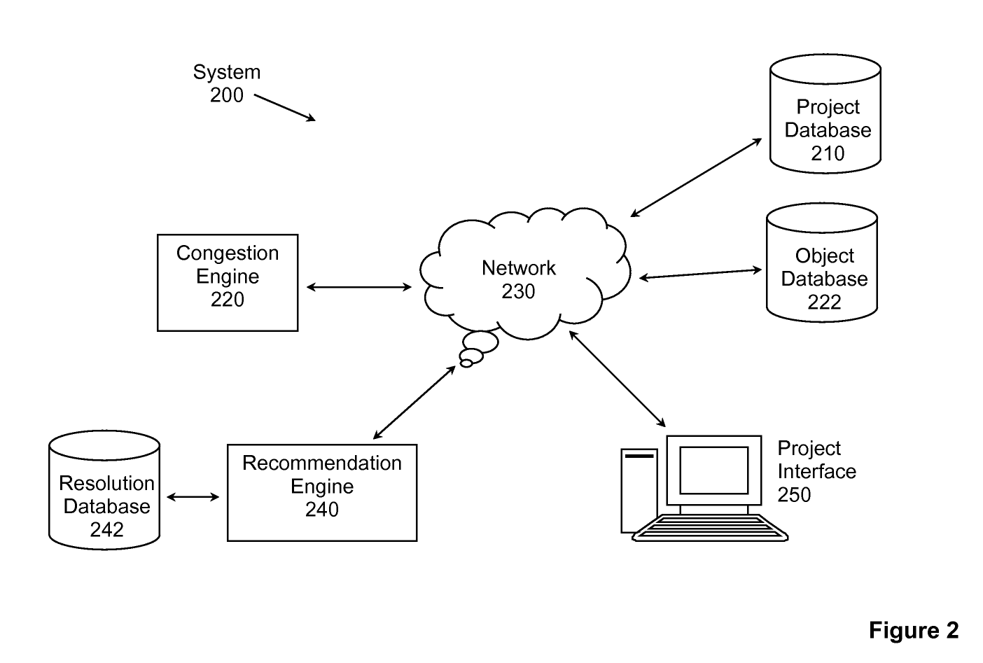

In FIG. 2, an embodiment of a system 200 for managing congestion points of a plant construction. The system 200 preferably includes a project database 210 configured to store at least one of project designs, resources, and activities, although it is contemplated that such information could alternatively be stored in any commercially suitable locations.

System 200 can also include a congestion engine 220 that is coupled with the project database 210 over a network 230. Network 230 could include an internal network such as a WAN, VPN, or other type of communications network, possibly operating as an overlay on the Internet's infrastructure, or an external network such as the Internet or other packet switched network. In addition, all commercially-suitable wired or wireless connections are contemplated

The congestion engine 220 preferably is configured to analyze the project designs, resources, and activities, and generate at least one congestion object, which could be stored in object database 222 or other suitable location.

It is contemplated that the at least one congestion object could have one or more attributes including, for example, a priority, a likelihood of congestion, a time, a location, a resource, an action, related congestion objects, and a congestion resolution. The priority attribute can advantageously represent the potential impact of the congestion object in the plant lifecycle. A congestion object might have a greater priority value depending upon the likelihood of a congestion occurring, the location of the congestion, and whether the congestion could trigger the occurrence of other congestion should that congestion occur (e.g., cascade effect). It is contemplated that a priority value of a congestion object can be based at least in part upon an associated LOC value and a resource value, although the priority value may also depend upon other attributes of the congestion object.

Thus, for example, it is contemplated that a first congestion object having a lower LOC value could be prioritized over a second congestion object having a higher LOC value if the congestion associated with the first congestion object could cause a considerable delay or cascading delays in a plant construction when compared with a minimal delay that could be caused by congestion associated with the second congestion object.

In some contemplated embodiments, the system 200 can further include a recommendation engine 240 such as that described above, which is configured to analyze the at least one congestion object and generate a recommendation to resolve the congestion object and thereby mitigate or eliminate potential delay represented by the congestion object. It is contemplated that the recommendation could include one or more suggested congestion resolutions, each of which could mitigate the potential congestion if implemented.

After a congestion resolution has been selected and associated with a congestion object, the congestion resolution can be stored in the resolution database 242 or other suitable location. The recommendation engine 240 can advantageously be configured to analyze these stored congestion resolutions to generate future recommendations, which allows the recommendation engine to increase the usefulness of its recommendations based upon previously-successful congestion resolutions.

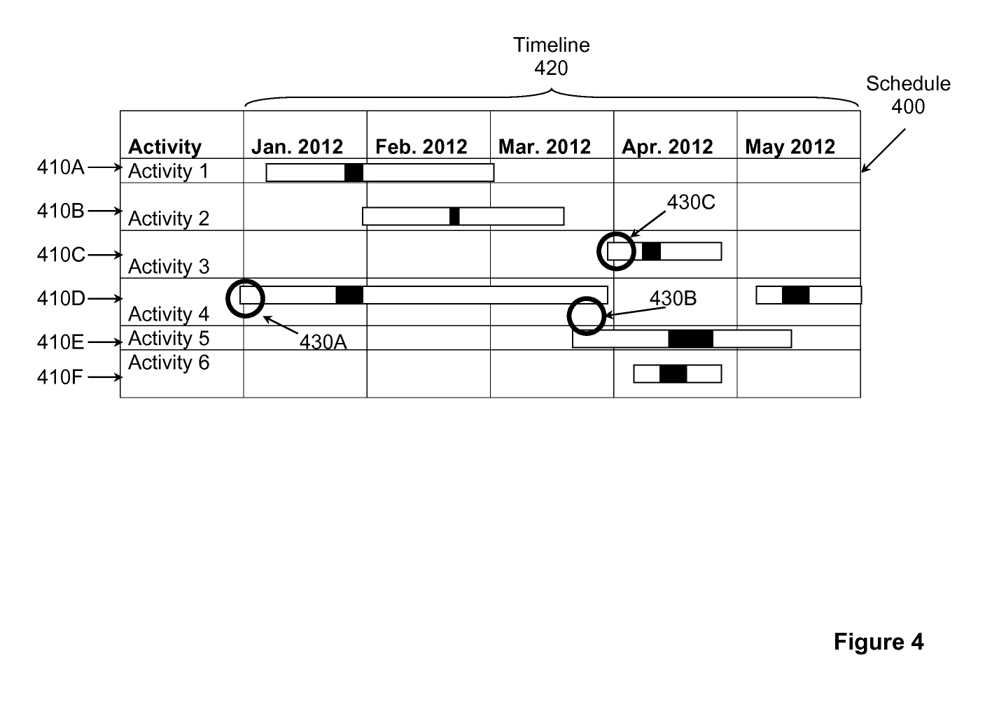

System 200 can further include a project interface 250 such as SmartPlant 3D™, StruPLANT™, EdgeWise Plant™, Optimize 3D™, Pro-Engineer™, or other suitable interface that is coupled with the project database 210 and configured to present the at least one congestion object to a user. It is preferred that the project interface 250 is configured to graphically overlay the at least one congestion object on a plant construction schedule such as that shown in FIG. 4. In this manner, a user can readily view potential congestion at each phase of a plant lifecycle. By associating a priority value with each of the at least one congestion objects, the congestion objects can be graphically distinguished from other congestion objects on the project interface 250 to enable a user to understand which congestion objects are likely to have a greater impact and/or are more likely to occur. For example, congestion objects having a higher priority value could be distinguished from those congestion objects with a low priority value using, for example, different colors, shapes, sizes, shadings, emphases, orders, and so forth.

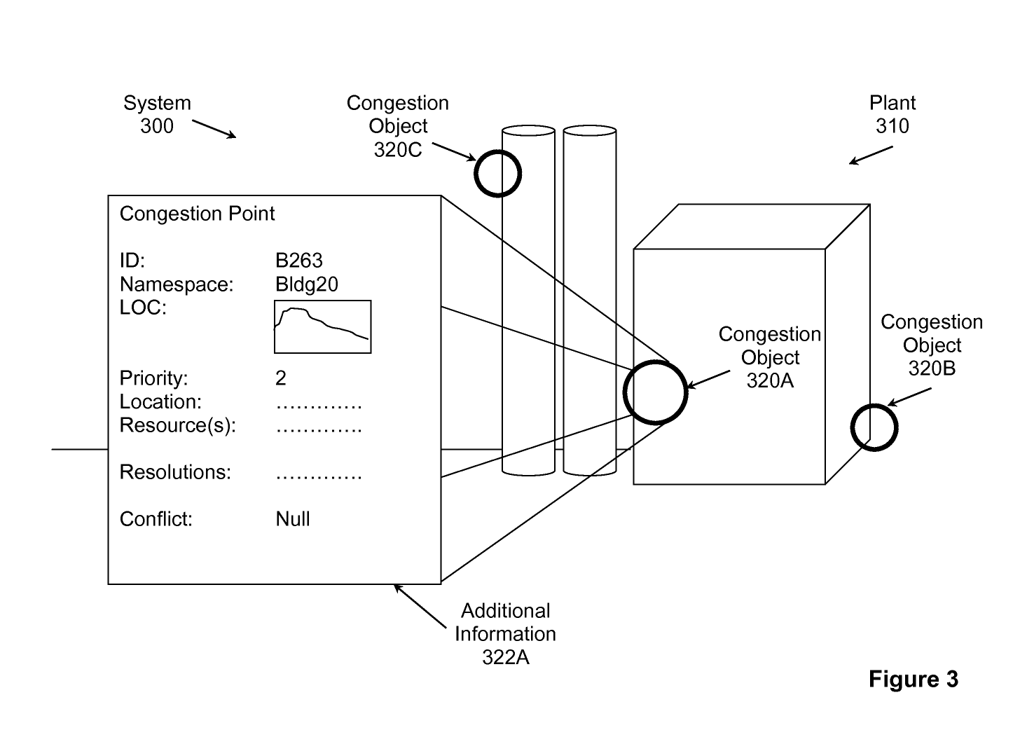

System 200 could further include a management interface shown in FIG. 3 configured to allow a user to edit one or more attributes of a congestion object, which could be integral to or separate from the project interface 250. In some contemplated embodiments, each congestion object can be associated with a set of conditions that must be met for the congestion object to be generated by the congestion engine. In such embodiments, the management interface is preferably configured to allow for editing of the set of conditions for each congestion object.

FIG. 3 illustrates one embodiment of a management interface 300 that illustrates a schematic of a plant 310 with multiple congestion objects 320A-C. Using the management interface 300, a congestion object 320A can be selected by a user to thereby display additional information 322A about the selected congestion objects 320A. The additional information can include various attributes of the congestion objects such as an identification value, namespace, LOC, priority, location, associated resource(s), suggesting resolution(s), and whether an actual conflict occurred related to the congestion object. In some contemplated embodiments, the additional information 322A can include one or more graphs illustrating a change in the priority and/or LOC values as a function of time.

Using the management interface 300, it is contemplated that the user can modify at least a portion of the additional information 322A. For example, a user could manually modify the priority of the congestion object 320A, or could select one of the suggested resolutions for implementation or further information about the suggested congestion resolution.

In FIG. 4, a simplified activity schedule 400 is displayed as a Gantt chart having six activities 410A-F that are scheduled to occur during timeline 420, although any commercially suitable chart(s) could be used. It is contemplated that each of the activities 410A-F could be scheduled using the critical path method or any other commercially suitable method(s) or combination thereof.

Using a congestion engine such as that described above, the activity schedule 400 can be analyzed to identity potential congestion points, and generate congestion objects 430A-C. For example, congestion object 430A might represent a resource congestion where a delay could occur in commencing activity 410D should necessary resources fail to arrive by the scheduled start date because those resources are in short supply. As another example, congestion object 430B might represent a space congestion where a delay could occur in commencing activity 410E because the space needed for activity 410E overlaps with the space needed to complete activity 410D. As yet another example, congestion object 430C might represent a scheduling congestion where the start of activity 410C is dependent upon the completion of activity 410D.

In some contemplated embodiments, each of the congestion objects 430A-C can be selected, such that additional information can be displayed about the selected congestion object including attributes associated with the selected congestion object. One or more of these attributes can preferably be edited by a user using a management interface or other suitable interface.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method for managing congestion points of a plant lifecycle, comprising:
providing access to a project database storing a first project that includes a preliminary or detailed design of a plant;
providing access to a congestion engine coupled with the project database, wherein the congestion engine comprises a processor configured to execute software instructions stored on a tangible, non-transitory computer readable storage medium;
analyzing, by the congestion engine processor, project designs, resources, and activities of the first project's preliminary or detailed design of the plant using one or more algorithms included in the software instructions to compare the project designs, project resources, and project activities with at least one of past project designs, past activities, and an availability of each resource;
generating at least one congestion object representing a potential congestion that may occur during a subsequent phase of a lifecycle of the plant, wherein the at least one congestion object is based at least in part upon the analysis of the congestion engine; and
configuring a project interface to present the at least one congestion object.

2. The method of claim 1, wherein the at least one congestion object comprises attributes.

3. The method of claim 2, wherein the attributes comprise a time, a location, and at least one of a resource and an action.

4. The method of claim 2, wherein the attributes comprise a likelihood of congestion.

5. The method of claim 4, wherein the attributes further comprise a resource, and wherein the method further comprises assigning each of the at least one congestion object a priority value based at least in part upon the likelihood of congestion and the resource.

6. The method of claim 5, wherein the step of configuring the project interface further comprises graphically distinguishing the at least one congestion object on the project interface as a function of the priority value.

7. The method of claim 2, further comprising the step of providing a management interface configured to allow a user to edit the attributes of the at least one congestion object.

8. The method of claim 7, wherein each of the at least one congestion object comprises a set of conditions, and wherein the management interface is configured to allow editing of the set of conditions.

9. The method of claim 1, further comprising:
providing access to a recommendation engine;
analyzing, by the recommendation engine, the at least one congestion object; and
generating a recommendation based upon the at least one congestion object.

10. The method of claim 9, further comprising:
associating a congestion resolution with the at least one congestion object;
storing the congestion resolution; and
wherein the step of analyzing by the recommendation engine further comprises analyzing associated congestion resolutions.

11. The method of claim 1, further comprising graphically overlaying the at least one congestion object on a plant construction schedule.

12. The method of claim 1, further comprising storing the at least one congestion object as a historical congestion object.

13. The method of claim 12, further comprising:
analyzing the historical congestion object to produce a likelihood of congestion value; and
assigning the likelihood of congestion value to the at least one congestion object.

14. The method of claim 1, wherein the activities comprise future activities.

15. The method of claim 1, wherein the activities include tasks required to complete, operate, or maintain the plant.
